(19) United States
(12) Patent Application Publication
(10) Pub. No.: US 2023/0108980 A1
(43) Pub. Date: Apr. 6, 2023

(54) DEPLETION MODELING FOR ESTIMATING SURVEY COMPLETENESS BY REGION

(71) Applicant: Chris Shughrue, Canaan, NY (US)

(72) Inventor: Chris Shughrue, Canaan, NY (US)

(21) Appl. No.: 17/487,774

(22) Filed: Sep. 28, 2021

(51) Int. Cl. G06Q 30/02; G06F 16/29

(52) U.S. Cl. CPC G06Q 30/0203; G06F 16/29

(57) ABSTRACT

Example systems, devices, media, and methods are described for predicting the total number of places or points of interest in a particular region, based on crowdsourced field reports, without reference to ground truth data. The method includes identifying a subset of captured field reports according to a region and an initial condition. The subset is arranged according to a series of records and a periodic time increment. The process of applying a depletion model includes, determining a catch quantity, determining an effort quantity, and calculating a catch rate based on the catch quantity compared to the effort quantity. A total place quantity for the region is predicted based on the catch rate compared to a cumulative catch count. The process of applying the depletion model includes generating a linear function to predict the total place quantity. The method further generates an estimated completeness for the region, which can be used to establish a market value.

### TECHNICAL FIELD

Examples set forth in the present disclosure relate to the field of electronic records and data analysis, including user-provided content. More particularly, but not by way of limitation, the present disclosure describes applying depletion models to estimate the completeness of surveys about a region.

### BACKGROUND

Maps and map-related applications include data about points of interest. Data about points of interest can be obtained from surveys or field reports submitted by users, in a practice known as crowdsourcing.

Crowdsourcing involves a large, relatively open, and evolving pool of users who can participate and gather real-time data without special skills or training. Crowdsourced data is inherently arbitrary. Regions densely populated with active users may generate a relatively high number of field reports compared to regions with fewer users.

Users have access to many types of computers and electronic devices today, such as mobile devices (e.g., smartphones, tablets, and laptops) and wearable devices (e.g., smartglasses, digital eyewear), which include a variety of cameras, sensors, wireless transceivers, input systems, and displays.

### BRIEF DESCRIPTION OF THE DRAWINGS

Features of the various examples described will be readily understood from the following detailed description, in which reference is made to the figures. A reference numeral is used with each element in the description and throughout the several views of the drawing. When a plurality of similar elements is present, a single reference numeral may be assigned to like elements, with an added lower-case letter referring to a specific element.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawing are the following figures:

FIG. 1 is an example map partitioned into a plurality of contiguous regions;

FIG. 2 is a flow chart listing the steps in an example method of predicting a total place quantity and estimating a completeness value associated with a region, in accordance with the depletion models described herein;

FIG. 3 is an example series of data, analyzed according to the depletion models described herein for predicting a total place quantity in a region;

FIG. 4A is a graph illustrating a first example linear function associated with a first portion of the series of data illustrated in FIG. 3;

FIG. 4B is a graph illustrating a second example linear function associated with a second portion of the series of data illustrated in FIG. 3;

FIG. 4C is a graph illustrating a third example linear function associated with a third portion of the series of data illustrated in FIG. 3;

FIG. 5 is the example series of data illustrated in FIG. 3, analyzed according to the depletion models described herein for estimating a completeness value associated with a selected region;

FIG. 6 is a diagrammatic representation of a machine in the form of a computer system within which a set of instructions may be executed for causing the machine to perform any one or more of the methods or processes described herein, in accordance with some examples; and

FIG. 7 is block diagram showing a software architecture within which the present disclosure may be implemented, in accordance with examples.

### DETAILED DESCRIPTION

Various implementations and details are described with reference to examples for predicting the total number of places in a region, based on crowdsourced field reports. For example, a depletion model is applied to a subset of field reports to calculate a catch rate based on a catch quantity compared to an effort quantity. The total place quantity for the region is predicted based on the catch rate compared to a cumulative catch count. The process of applying the depletion model includes generating a linear function to predict the total place quantity. The method further generates an estimated completeness for the region, which can be used to establish a market value.

Example methods include capturing a plurality of field reports, wherein each field report comprises a user identifier, a place identifier, a submission timestamp, and an action type selected from the group consisting of Add and Edit. The method includes identifying a subset of the captured field reports according to a region and an initial condition. Using a depletion model, the method includes determining a catch quantity associated with a series of records established according to a periodic time increment, wherein each catch quantity represents a number of field reports characterized by an Add report type. The method further includes determining an effort quantity associated with each record, wherein each effort quantity represents a total number of field reports.

Using the depletion model, the method includes calculating a catch rate associated with each record, wherein each catch rate represents the catch quantity compared to the effort quantity. The method also includes maintaining a cumulative catch count associated with each record. The method includes predicting a total place quantity for the region based on the catch rate and the cumulative catch count associated with a prediction record. In some implementations, the depletion model is a linear regression model and the process of predicting a total place quantity includes generating a linear function based on the calculated catch rate compared to the maintained cumulative catch count. The predicted total place quantity can be used to estimate a completeness value, and a market value, associated with the region.

Although the various systems and methods are described herein with reference to predicting the number of places in a region, the technology described may be applied to evaluating any series of records with a mathematical or statistical model.

The following detailed description includes systems, methods, techniques, instruction sequences, and computing machine program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and method described because the relevant teachings can be applied or practice in a variety of ways. The terminology and nomenclature used herein is for the purpose of describing particular aspects only and is not intended to be limiting. In general, well-known instruction instances, protocols, structures, and techniques are not necessarily shown in detail.

The terms “coupled” or “connected” as used herein refer to any logical, optical, physical, or electrical connection, including a link or the like by which the electrical or magnetic signals produced or supplied by one system element are imparted to another coupled or connected system element. Unless described otherwise, coupled or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element that is integrated into or supported by the element.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In an example context of map-related mobile applications, a user may submit a field report about a new place (e.g., an Add action type) or about an existing place (e.g., an Edit action type). In some applications, the format of a field report includes place data that is limited to a predefined set of attributes, some of which are expected to be relatively static over time (e.g., name, address, business type, telephone number) while others are subject to change or dynamic (e.g., admission policies, hours of operation, amenities). A field report submitted by a user, for example, includes a data submission or label (e.g., café) associated with a particular attribute (e.g., business type). The field report need not include a label for each and every attribute. For example, an Edit action may include a single label associated with one attribute of a place. An Add action may include labels for most or all the attributes about a place.

Users and participating businesses want place data that reflects the objective ground truth; in other words, place data that is accurate, reliable, and up to date. Ground truth place data can be sought by purchasing proprietary third-party datasets or by sending expert investigators into the field. Hiring expert content moderators to investigate takes time and adds expense.

Of particular interest is whether the data about places and points of interest in a particular geographic area or region is complete. In other words; to what extent does our data include at least one field report about every place in the region? Crowdsourced data is inherently arbitrary and, therefore, resistant to analysis using sampling correction methodologies that are sometimes applied to more structured survey data.

Ground truth place data might include the total number of places in a region; however, that total is subject to change over time as places open and close. The systems and methods described herein, in one aspect, estimate the completeness of crowdsourced place data without relying on an external or objective source of ground truth place data.

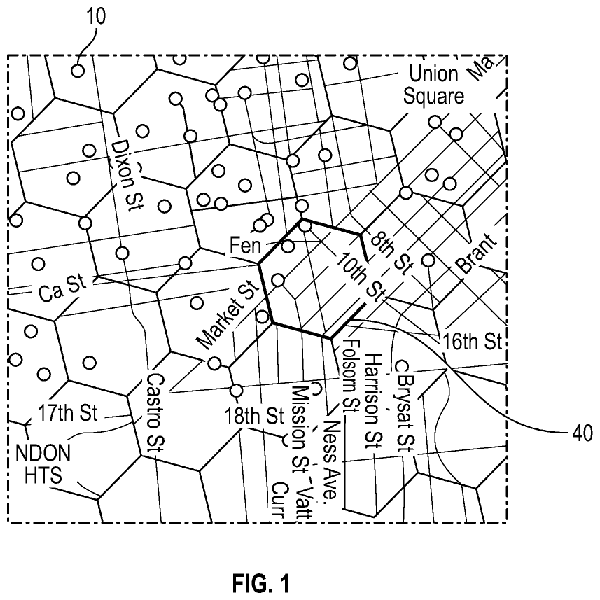

FIG. 1 is an example map partitioned into a plurality of contiguous regions. In some implementations, a geospatial indexing model includes a grid system of hexagonal cells or regions. The hexagonal regions are generally contiguous, meaning they fit together closely with little or no gaps or overlapping. Large hexagons may be applied to remote or less populated areas, whereas a grid of relatively smaller hexagons is applied to more densely populated areas. A geospatial indexing model that is suitable for use in the region-based methods described herein is based on or includes the H3 grid-based spatial indexing system developed by Uber Technologies, Inc.

The example map shown in FIG. 1, as shown, includes one or more field reports 10 about points of interest or places within each hexagonal region 40.

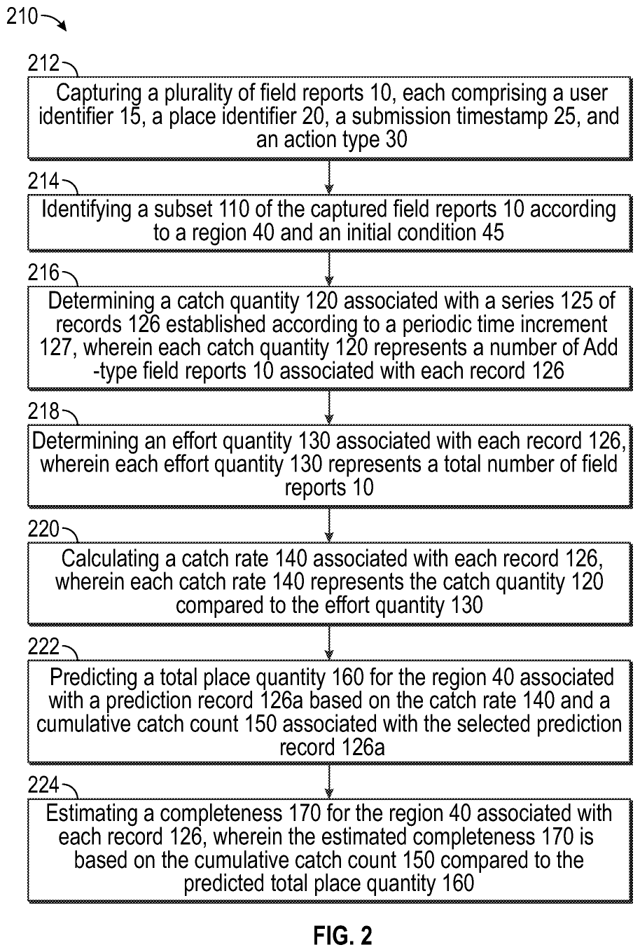

FIG. 2 is a flow chart 210 listing the steps in an example method of predicting a total place quantity and estimating a completeness value associated with a region, in accordance with the depletion models described herein. Although the steps are described with reference to field reports and place data, other beneficial uses and implementations of the steps described will be understood by those of skill in the art based on the description herein. One or more of the steps shown and described may be performed simultaneously, in a series, in an order other than shown and described, or in conjunction with additional steps. Some steps may be omitted or, in some applications, repeated.

In some example implementations, a field report 10 includes a user identifier 15, a place identifier 20, a submission timestamp 25, and an action type 30. In some implementations, the action types 30 include Add 31 (e.g., submitting a field report 10 for a new place) or Edit 32 (e.g., submitting a field report 10 including one or more suggested edits, changes, corrections, or other data about one or more place attributes associated with a place that was previously added), as well as other action types.

The user identifier 15 in some implementations includes a username, a device identifier (e.g., a device IP address, device metadata), geolocation data associated with a user device (e.g., image metadata in EXIF format), and other indicia associated with a particular person who is a participating or registered user. The submission timestamp 25 in some implementations represents the date and clock time when a field report 10 is submitted by a user. The place identifier 20 in some implementations includes a place name, a unique place number (e.g., a reference or serial number), a geospatial identifier (e.g., geographic metadata, GPS data), and other indicia associated with the geographic place where a field report 10 was submitted.

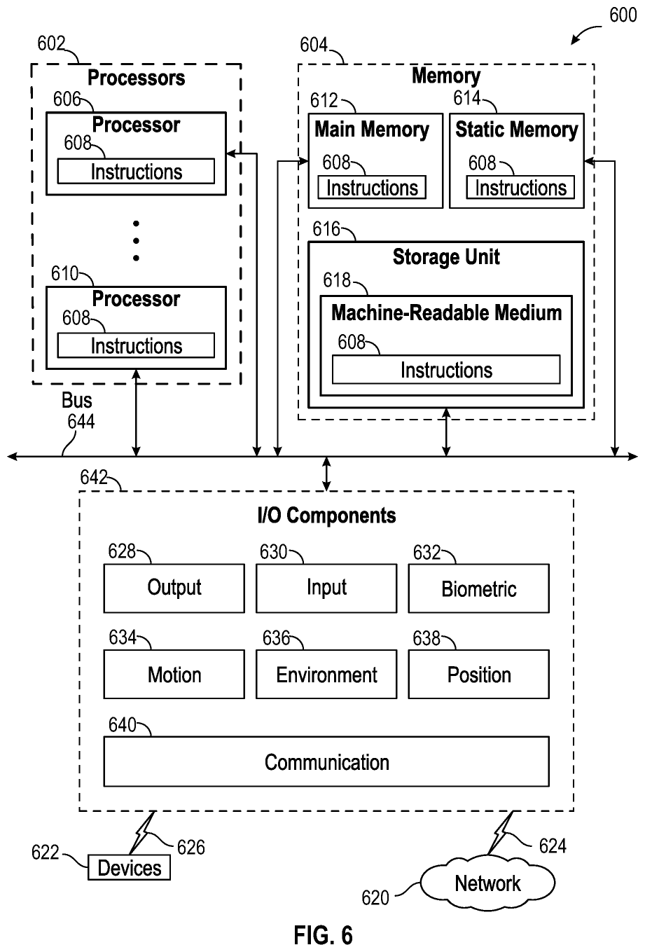

Field reports 10 may be stored in a memory 604 (FIG. 6; e.g., in a field report database or set of relational databases) of one or more computing devices 600 (FIG. 6), such as those described herein. Similarly, user records may be stored in a memory 604 (e.g., in a user database or set of relational databases) of one or more computing devices 600. A user record in some implementations includes a user identifier 15, a user credibility score, and a variety of other user-specific data and information.

A field report 10 in some implementations includes one or more user-submitted labels, including one or more characters (e.g., letters, words, digits, blank spaces, punctuation), a value (e.g., a selection from a menu, a value associated with a particular variable), or any other indicia associated with or representing a place attribute 20. A place attribute 20 in some implementations includes any of a variety of attributes associated with a place or point of interest, including attributes that are expected to remain relatively static over time (e.g., name, address, business type, telephone number) and other attributes that are relatively dynamic, variable, or subject to change over time (e.g., admission policies, hours of operation, amenities). For example, a user-submitted label that includes the text string “Acme Bank” may be submitted to represent the place attribute 20 entitled “Business Name.” Another example user-submitted label that includes the numerical value 8 may be submitted to represent the place attribute 20 entitled “Open Hours on Mondays.”

Block 212 in FIG. 1 describes an example step of capturing a plurality of field reports 10, wherein each field report comprises a user identifier 15, a place identifier 20, a submission timestamp 25, and an action type 30 (e.g., an Add 31 or an Edit 32). In some implementations, the step of capturing includes storing the plurality of field reports 10 in one or more databases, or in the memory element of one or more computing devices.

Block 214 in FIG. 1 describes an example step of identifying a subset 110 of the captured field reports according to a region 40 (e.g., one of the regions 40 shown in FIG. 1) and an initial condition 45. In some implementations, the step of identifying a subset includes retrieving field reports 10 from memory or from one or more databases.

In some implementations the region 40 is identified or otherwise selected based on the initial condition 45. In practice, when a candidate region has been selected and a series 125 of records 126 has been generated according to a periodic time increment 127, as described herein, the step of identifying a subset 110 includes determining whether the initial condition 45 is satisfied (or not). The initial condition 45, in some implementations, includes a requirement that a first record 126 includes a field report 10 that includes the first Add 31 for a place associated with a particular candidate region (e.g., suggesting a first Add 31 in the region 40, where no previous Add has been submitted). In some implementations, the initial condition 45 may be based on a minimum increase in catch quantity 120, as described herein, between subsequent records 126 (e.g., suggesting a sudden increase in the number of Adds 31 in the region 40). The minimum increase may be compared to a predetermined threshold value (e.g., at least one additional Add 31, a ten percent increase in Adds 31).

If an initial condition 45 is not satisfied, then the step of identifying a subset 110 may include selecting a different or subsequent region 40 for analysis or, in some implementations, selected a different or subsequent initial condition 45 applied to the same region 40. In this aspect, the region 40 and the initial condition 45 are selected and evaluated in relation to one another, in some implementations, when performing the step of identifying a subset 110.

The depletion models 100 described herein, in some implementations, are particularly useful in evaluating regions with few or zero places Added and where field reports 10 are beginning to be submitted by users. For example, there may be little or no place data about points of interest in a candidate region that is located in a new market (e.g., a new city after release of an application) or a remote location (e.g., a resort town or island destination). In contrast, established regions that are densely populated with active users, typically, will include relatively few Add-type actions about new places (e.g., when a new point of interest or places opens).

Block 216 in FIG. 1 describes an example step, for an identified subset 110, of determining a catch quantity 120 associated with a series 125 of records 126 established according to a periodic time increment 127. The periodic time increment 127, in some implementations, is a predetermined or selected time value (e.g., 24 hours, 3 days, 7 days). Each established record 126 spans one periodic time increment 127 (e.g., a 24-hour period) and is populated with the received field reports 10 according to the submission timestamp 25.

The periodic time increment 127, in some implementations, is repeating and regular (e.g., the same increment for all the records 126 in the series 125). A regular or consistent periodic time increment 127, in some implementations, is best suited to the depletion models 110 described herein. For example, a linear regression model generally requires a series 125 of records 126 established according to a regular periodic time increment 127.

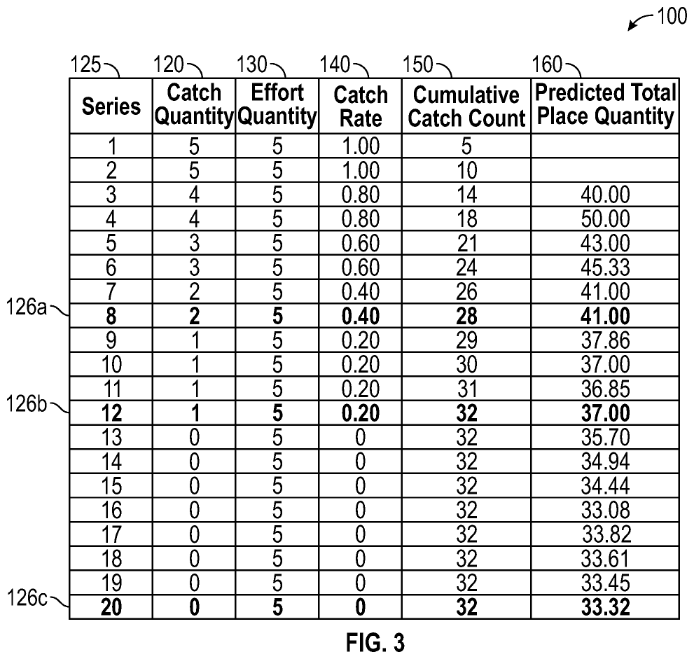

Each record 126 includes data related to all the field reports 10 in the subset 110 received during the time increment 127 associated with each record. An example series 125 of records 126 is shown in FIG. 3. For example, the first record 1 in the series 125 includes data about all the field reports 10 in the subset 110 received during the first time increment 127 (e.g., one day).

In some implementations, the example step of determining a catch quantity 120 includes, for each record 126, counting the number of Add-type field reports (e.g., the number of field reports 10 that are characterized by an Add 31 action type). The catch quantity 120 in this aspect represents the number of new place Adds 31 submitted by users in the region 40 during the time period associated with each record 126. The number of Adds 31 is referred to as a catch quantity 120 because the submission of a Add-type field report about a new place is analogous, in some respects, to catching or identifying wildlife in a particular region. As the catch quantity 120 increases, there are fewer un-reported places remaining to be caught or identified.

In some implementations, the process of (at block 216) of establishing a series 125 of records 126 established according to a periodic time increment 127 is performed in tandem or otherwise correlated with the step (at block 214) of identifying a subset 110 of the captured field reports according to a region 40 and an initial condition 45. For example, a first periodic time increment 127 (e.g., 24 hours) may produce a series 125 of records 126 which does not satisfy the initial condition 45, as described herein, whereas a second or alternative periodic time increment 127 (e.g., 12 hours) (when applied to the same subset 110 of field reports 10) may produce a series 125 of records 126 which satisfies the initial condition 45. In this aspect, one or more of the steps described in FIG. 2 may be repeated or performed in conjunction with other steps; for example, by selecting an alternative periodic time increment 127, determining whether the initial condition 45 is satisfied, and repeating this process, as necessary. For some subsets 110 of field reports 10, the initial condition 45 may not be satisfied across the series 215 of records 126 established according to any selected periodic time increment 127. For other subsets 110, the initial condition 45 may be satisfied for only one or relatively few selected periodic time increments 127.

Block 218 in FIG. 1 describes an example step of determining an effort quantity 130 associated with each record 126, wherein each effort quantity 130 represents a total number of field reports 10 (e.g., all types, including Adds 31 and Edits 32). The effort quantity 130 in this aspect represents an estimate of the total field-report activity by users in the region 40 during the time period associated with each record 126. In general, map-related applications gather and store a variety of user data (e.g., usage data, geographic metadata, transaction logs) which might be used as a proxy for user effort. The effort quantity 130, however, in this example implementation is based on the total number of field reports 10 submitted (e.g., Adds and Edits). In this aspect, the estimated user effort is correlated with the task of submitting as field report 10 of any type.

Block 220 in FIG. 1 describes an example step of calculating a catch rate 140 associated with each record 126, wherein each catch rate 140 represents the catch quantity 120 (e.g., the Add 31 report types) compared to the effort quantity 130 (e.g., all reports) associated with each record 126. The catch rate 140 in some implementations is calculated by the catch quantity 120 divided by the effort quantity 130 (e.g., expressed as a ratio or a percentage). For example, for record 126a in FIG. 3, the catch rate 140 is two, the effort quantity 130 is five, and the catch rate 140 is two divided by five; expressed as 0.40 or 40%.

Block 222 in FIG. 1 describes an example step of predicting a total place quantity 160 associated with a particular record (e.g., a prediction record 126a) in the series 125. The predicted total place quantity 160 in some implementations is based on the catch rate 140 and the cumulative catch count 150 associated with the prediction record 126a. In this aspect, this example step includes maintaining a cumulative catch count 150 associated with each record 126 in the series 125, as shown in FIG. 3.

As more and more field reports 10 are submitted about a particular region 40, the number of new places added (i.e., the catch quantity 120) over time will approach zero (e.g., when there are few or no additional places to be added). Accordingly, as shown in FIG. 3, as the catch quantity 120 decreases, the calculated catch rate 40, over time, will approach zero.

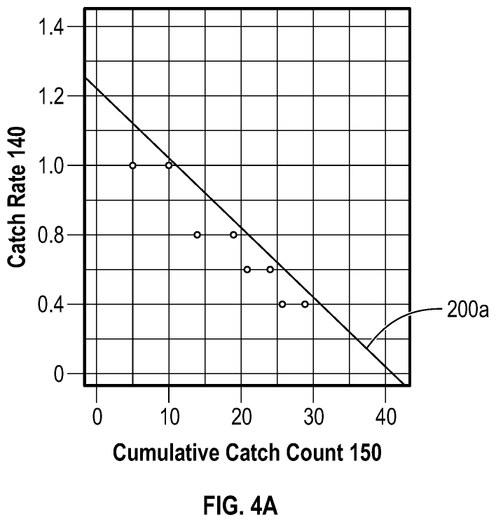

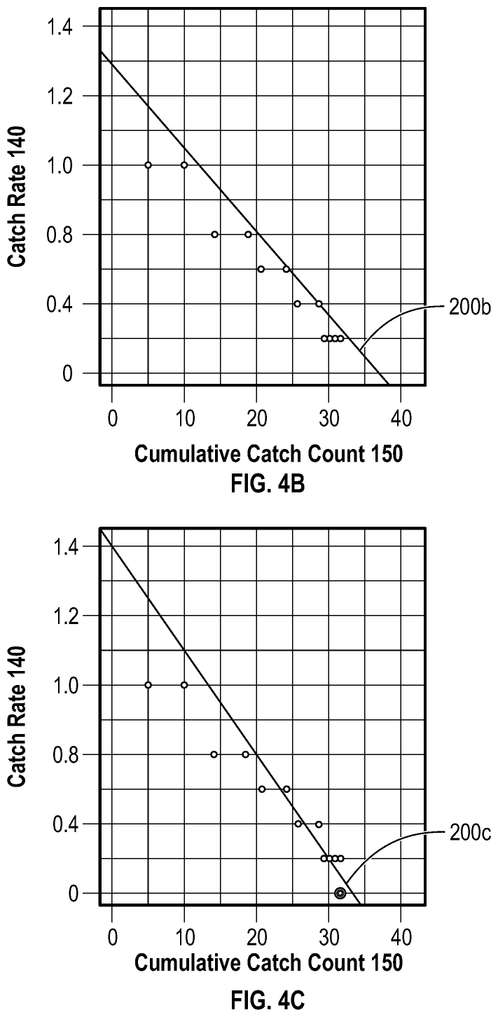

FIG. 4A is a graph of the example data shown in FIG. 3 associated with a prediction record 126a in the series 125. As shown, the graph in FIG. 4A is a Cartesian coordinate system showing each data point in FIG. 3 as a hollow dot, in which the abscissa value along the x-axis is the cumulative catch count 150 and the ordinate value along the y-axis is the calculated catch rate 40. In some implementations, the example step of predicting a total place quantity 160 (block 222 in FIG. 1) includes generating a graph and plotting the calculated catch rate 40 over time versus the cumulative catch count 150, as shown in FIG. 4A.

The known data points associated with the prediction record 126a (FIG. 3) are plotted on the graph in FIG. 4A and show that the calculated catch rate 40 is trending toward zero as the cumulative catch count 150 increases. Curve fitting describes the process of constructing a curve or finding a mathematical function that best fits a series of known data points. In statistics, a linear regression model assumes that the best-fit mathematical function is linear. A linear regression model fits a line to the known data points. The resulting linear function has the form y=mx+b, where m is the slope of the line and b is the y-intercept value (i.e., the value of y when the line crosses the y-axis (for x equals zero)). For a given linear function, the x-intercept value (i.e., the value of x when the line crosses the x-axis) can be calculated by setting y equal to zero and solving for x.

In some implementations, the example step at block 222 of predicting a total place quantity 160 includes applying a depletion model 100. The depletion model 100 in some implementations is a linear regression model which, when applied to the established series 125 of records 126 generates a linear function that is based on the calculated catch rate 140 and the maintained cumulative catch count 150. The depletion model 100 in some implementations is applied as part of a system for predicting the total place quantity 160 associated with a region 40, estimating a completeness 170, and establishing a market value associated with the region 40, as described herein.

The graph in FIG. 4A includes a line 200a plotted according to a first example linear function generated by applying an example depletion model 100 (e.g., a linear regression model) to the known data points associated with the prediction record 126a in FIG. 3. As shown, when the calculated catch rate 140 reaches zero (y equals zero), the line 200a intercepts the x-axis at a value of 41.00, which represents the predicted total place quantity 160. In this aspect, applying the depletion model 100 to the known data points produces a linear function and an x-intercept value, which represents the predicted total place quantity 160. The final column of FIG. 3 shows the predicted total place quantity 160 associated with each record 126.

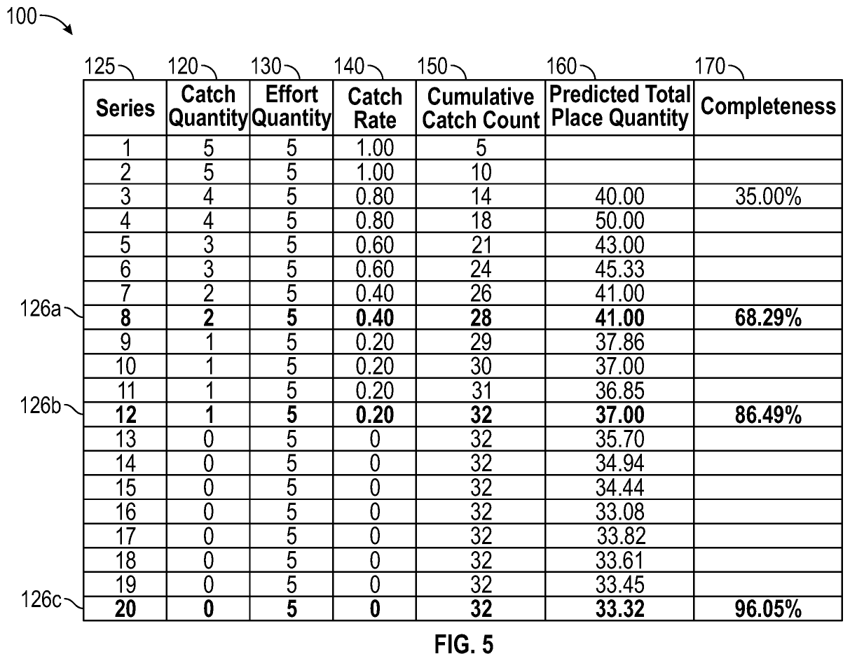

The graph in FIG. 4B includes a line 200b plotted according to a second example linear function generated by applying an example depletion model 100 to the known data points associated with the prediction record 126b in FIG. 3. As shown, the calculated catch rate 40 equals 0.20 for a total of four records leading up to and including the prediction record 126b. These four data points are shown in FIG. 4B. The predicted total place quantity 160 associated with record 126b equals 37.00. Also, the estimated completeness 170 (shown in FIG. 5 for record 126b) has increased to 86.49%.

In another example, the graph in FIG. 4C includes a line 200c plotted according to a third example linear function generated by applying an example depletion model 100 to the known data points associated with the prediction record 126c in FIG. 3. As shown, the calculated catch rate 40 equals zero and the cumulative catch count 150 equals 32 for a total of eight (8) records leading up to and including the prediction record 126c. These eight data points are overlapping and therefore shown in FIG. 4C as a collection of concentric dots, located at x-y coordinates (32, 0) on the graph. The predicted total place quantity 160 associated with record 126c equals 33.32. Also, the estimated completeness 170 (shown in FIG. 5 for record 126c) has increased to 96.05%.

Referring to the graphs in FIGS. 4A, 4B, and 4C, the depletion model 100 generates linear functions that change over time, each having a different slope and a different x-intercept (i.e., a different predicted total place quantity 160).

In some implementations, the generation or analysis of the records 126 in the series 125 may be halted or discontinued when the estimated completeness 170 approaches a threshold value (e.g., 95% complete) or, in other implementations, when another selected value or ratio approaches a minimum or a maximum threshold value.

In a related aspect, the example step of predicting a total place quantity 160 (block 222 in FIG. 1) in some implementations includes calculating a confidence value associated with the predicted total place quantity 160. The depletion model 100 in some implementations includes a statistical model (e.g., linear regression,) the results of which can be analyzed to determine a probability distribution. For example, when the depletion model 100 produces a linear function, there is a probability distribution associated with the value of X when Y equals zero. In other words, the probability that the predicted total place quantity 160 (i.e., the x-intercept value) is correct can be calculated using statistical analysis. In practice, for example, the predicted total place quantity 160 may be expressed as a quantity of places (e.g., 41.00) along with a confidence value, expressed as a ratio or a percentage (e.g., 60%).

Referring again to FIG. 3, for record 126a, the cumulative catch count 150 (based on the actual field reports 10 submitted about this particular region 40) is 28. The predicted total place quantity 160 is 41.00, which represents a prediction of the cumulative catch count 150 when all the Add-type actions about new places in the region 40 have been submitted.

Block 224 in FIG. 1 describes an example step of estimating a completeness 170 for the region 40 associated with each record 126, wherein the estimated completeness 170 is based on the cumulative catch count 150 compared to the predicted total place quantity 160. The completeness 170 in some implementations is calculated by the cumulative catch count 150 divided by the predicted total place quantity 160 (e.g., expressed as a ratio or a percentage). For example, for record 126a in FIG. 3, the cumulative catch count 150 is 28, the predicted total place quantity 160 is 41.00, and the estimated completeness 170 is 28 divided by 41; expressed as 68.29 percent (tabulated for several example records 126 in FIG. 5). As shown in FIG. 5, as the calculated catch rate 40 approaches zero, over time, the completeness 170 increases, trending toward 100%.

In a related aspect, the estimated completeness 170 in some implementations represents all or part of the basis for establishing a market value associated with the region 40. As used herein, the market value may represent or be associated with advertising rates (e.g., for business partners who wish to advertise to users in the region 40), placement offers (e.g., charging a fee for curating or otherwise submitting an Add-type field report 10 about a particular point of interest or place within the region 40), user incentives (e.g., bonus points, prizes, credits, or cash offered to users who submit an Add-type field report 10 about a place within the region 40, to encourage a higher catch quantity 120), or for other business or strategic purposes. For owners of business places or other points of interest, in this context, the estimated completeness 170 affects the perceived market value associated with the reaching out to users in a region 40. For example, a relatively high estimated completeness 170 represents a region 40 that is likely saturated with active users, which may or may not be a good fit with the goals of business owners. A relatively low estimated completeness 170 may represent a region 40 that is just beginning to attract more active users, which may be an opportunity to reach out to such users with incentives, offers, or promotions.

FIG. 6 is a diagrammatic representation of a machine 600 within which instructions 608 (e.g., software, a program, an application, an applet, an app, or other executable code) for causing the machine 600 to perform any one or more of the methodologies discussed herein may be executed. For example, the instructions 608 may cause the machine 600 to execute any one or more of the methods described herein. The instructions 608 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines that individually or jointly execute the instructions 608 to perform any one or more of the methodologies discussed herein.

The machine 600 may include processors 602, memory 604, and input/output (I/O) components 642, which may be configured to communicate with each other via a bus 644. In an example, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that execute the instructions 608. The term “processor” is intended to include multi-core processors that may comprise two or more independent processors (sometimes referred to as “cores”) that may execute instructions contemporaneously. Although multiple processors 602 are shown, the machine 600 may include a single processor with a single core, a single processor with multiple cores (e.g., a multi-core processor), multiple processors with a single core, multiple processors with multiples cores, or any combination thereof.

The memory 604 includes a main memory 612, a static memory 614, and a storage unit 616, both accessible to the processors 602 via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 (e.g., a non-transitory machine-readable storage medium) within the storage unit 616, within at least one of the processors 602 (e.g., within the processor's cache memory), or any suitable combination thereof, during execution thereof by the machine 600.

Furthermore, the machine-readable medium 618 is non-transitory (in other words, not having any transitory signals) in that it does not embody a propagating signal. However, labeling the machine-readable medium 618 “non-transitory” should not be construed to mean that the medium is incapable of movement; the medium should be considered as being transportable from one physical location to another. Additionally, since the machine-readable medium 618 is tangible, the medium may be a machine-readable device.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones may include a touch input device or other such input mechanisms, while a headless server machine will likely not include such a touch input device. It will be appreciated that the I/O components 642 may include many other components that are not shown. In various examples, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, a resistance feedback mechanism), other signal generators, and so forth. The input components 630 may include alphanumeric input components (e.g., a keyboard, a touch screen configured to receive alphanumeric input, a photo-optical keyboard, or other alphanumeric input components), pointing-based input components (e.g., a mouse, a touchpad, a trackball, a joystick, a motion sensor, or another pointing instrument), tactile input components (e.g., a physical button, a touch screen that provides location, force of touches or touch gestures, or other tactile input components), audio input components (e.g., a microphone), and the like.

In further examples, the I/O components 642 may include biometric components 632, motion components 634, environmental components 636, or position components 638, among a wide array of other components. For example, the biometric components 632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 include acceleration sensor components (e.g., accelerometer), gravitation sensor components, rotation sensor components (e.g., gyroscope), and so forth. The environmental components 636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 further include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near-field Communication (NFC) components, Bluetooth® components (e.g., Bluetooth® Low Energy), WiFi® components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

The various memories (e.g., memory 604, main memory 612, static memory 614, memory of the processors 602), storage unit 616 may store one or more sets of instructions and data structures (e.g., software) embodying or used by any one or more of the methodologies or functions described herein. These instructions (e.g., the instructions 608), when executed by processors 602, cause various operations to implement the disclosed examples.

The instructions 608 may be transmitted or received over the network 620, using a transmission medium, via a network interface device (e.g., a network interface component included in the communication components 640) and using any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622.

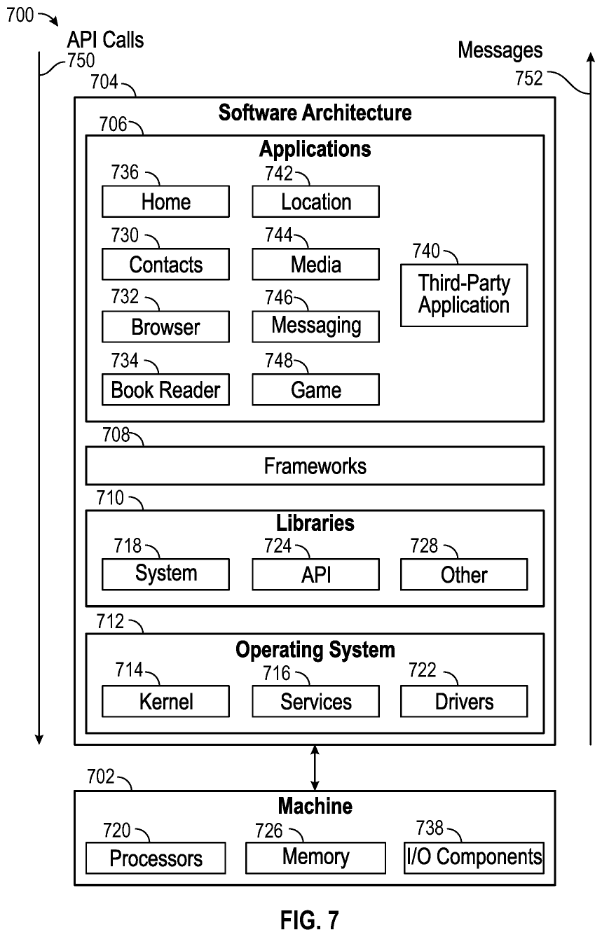

FIG. 7 is a block diagram 700 illustrating a software architecture 704, which can be installed on any one or more of the devices described herein. The software architecture 704 is supported by hardware such as a machine 702 that includes processors 720, memory 726, and I/O components 738. In this example, the software architecture 704 can be conceptualized as a stack of layers, where each layer provides a particular functionality. The software architecture 704 includes layers such as an operating system 712, libraries 710, frameworks 708, and applications 706. Operationally, the applications 706 invoke API calls 750 through the software stack and receive messages 752 in response to the API calls 750.

The operating system 712 manages hardware resources and provides common services. The operating system 712 includes, for example, a kernel 714, services 716, and drivers 722. The kernel 714 acts as an abstraction layer between the hardware and the other software layers. For example, the kernel 714 provides memory management, processor management (e.g., scheduling), component management, networking, and security settings, among other functionality. The services 716 can provide other common services for the other software layers. The drivers 722 are responsible for controlling or interfacing with the underlying hardware. For instance, the drivers 722 can include display drivers, camera drivers, Bluetooth® or Bluetooth® Low Energy (BLE) drivers, flash memory drivers, serial communication drivers (e.g., Universal Serial Bus (USB) drivers), Wi-Fi® drivers, audio drivers, power management drivers, and so forth.

The libraries 710 provide a low-level common infrastructure used by the applications 706. The libraries 710 can include system libraries 718 (e.g., C standard library) that provide functions such as memory allocation functions, string manipulation functions, mathematic functions, and the like. In addition, the libraries 710 can include API libraries 724 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., a WebKit® engine to provide web browsing functionality), and the like. The libraries 710 can also include a wide variety of other libraries 728 to provide many other APIs to the applications 706.

The frameworks 708 provide a high-level common infrastructure that is used by the applications 706. For example, the frameworks 708 provide various graphical user interface (GUI) functions, high-level resource management, and high-level location services. The frameworks 708 can provide a broad spectrum of other APIs that can be used by the applications 706, some of which may be specific to a particular operating system or platform.

In an example, the applications 706 may include a home application 736, a contacts application 730, a browser application 732, a book reader application 734, a location application 742, a media application 744, a messaging application 746, a game application 748, and a broad assortment of other applications such as a third-party application 740. The third-party applications 740 are programs that execute functions defined within the programs.

In a specific example, a third-party application 740 (e.g., an application developed using the Google Android or Apple iOS software development kit (SDK) by an entity other than the vendor of the particular platform) may be mobile software running on a mobile operating system such as Google Android, Apple iOS (for iPhone or iPad devices), Windows Mobile, Amazon Fire OS, RIM BlackBerry OS, or another mobile operating system. In this example, the third-party application 740 can invoke the API calls 750 provided by the operating system 712 to facilitate functionality described herein.

Various programming languages can be employed to create one or more of the applications 1006, structured in a variety of manners, such as object-oriented programming languages (e.g., Objective-C, Java, C++, or R) or procedural programming languages (e.g., C or assembly language). For example, R is a programming language that is particularly well suited for statistical computing, data analysis, and graphics.

Any of the functionality described herein can be embodied in one or more computer software applications or sets of programming instructions. According to some examples, “function,” “functions,” “application,” “applications,” “instruction,” “instructions,” or “programming” are program(s) that execute functions defined in the programs. Various programming languages can be employed to develop one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may include mobile software running on a mobile operating system such as IOS™, ANDROID™, WINDOWS® Phone, or another mobile operating system. In this example, the third-party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer devices or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as plus or minus ten percent from the stated amount or range.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method, comprising:
capturing a plurality of field reports, wherein each field report comprises a user identifier, a place identifier, a submission timestamp, and an action type selected from the group consisting of Add and Edit;
identifying a subset of the captured field reports according to a region and an initial condition;
determining a catch quantity associated with a series of records established according to a periodic time increment, wherein each catch quantity represents a number of field reports characterized by an Add report type;
determining an effort quantity associated with each record, wherein each effort quantity represents a total number of field reports;
calculating a catch rate associated with each record, wherein each catch rate represents the catch quantity compared to the effort quantity;
maintaining a cumulative catch count associated with each record; and
predicting a total place quantity for the region based on the catch rate and the cumulative catch count associated with a prediction record.

2. The method of claim 1, wherein the step of identifying a subset further comprises:
applying a geospatial indexing model that partitions a mapped area of interest into a plurality of regions; and
selecting the region based on the initial condition, wherein the initial condition is based on a minimum increase in catch quantity between subsequent records, compared to a predetermined threshold value.

3. The method of claim 1, wherein the step of calculating a catch rate further comprises:
dividing the catch quantity by the effort quantity for each record in the series.

4. The method of claim 1, wherein the step of predicting a total place quantity further comprises:
generating a linear function based on a depletion model applied to the established series of records, wherein the linear function associated with each record is based on the calculated catch rate and the maintained cumulative catch count; and
calculating the predicted total place quantity based on the generated linear function.

5. The method of claim 4, wherein the depletion model comprises a linear regression model,
wherein the predicted total place quantity is based on the generated linear function when the calculated catch rate is equal to zero, and
wherein the method further comprises calculating a confidence value based on a probability distribution associated with the predicted total place quantity.

6. The method of claim 1, further comprising:
estimating a completeness for the region associated with each record, wherein the estimated completeness is based on the cumulative catch count compared to the predicted total place quantity.

7. The method of claim 6, further comprising:
establishing a market value associated with each region based on the estimated completeness.

8. A system for predicting a total place quantity associated with a region, comprising:
a memory that stores instructions; and
a processor configured by the stored instructions to perform operations comprising the steps of:
capturing a plurality of field reports, wherein each field report comprises a user identifier, a place identifier, a submission timestamp, and an action type selected from the group consisting of Add and Edit;
identifying a subset of the captured field reports according to a region and an initial condition;
determining a catch quantity associated with a series of records established according to a periodic time increment, wherein each catch quantity represents a number of field reports characterized by an Add report type;
determining an effort quantity associated with each record, wherein each effort quantity represents a total number of field reports;
calculating a catch rate associated with each record, wherein each catch rate represents the catch quantity compared to the effort quantity;
maintaining a cumulative catch count associated with each record; and
predicting a total place quantity for the region based on the catch rate and the cumulative catch count associated with a prediction record.

9. The system of claim 8, wherein the step of identifying a subset further comprises:
applying a geospatial indexing model that partitions a mapped area of interest into a plurality of regions; and
selecting the region based on the initial condition, wherein the initial condition is based on a minimum increase in catch quantity between subsequent records, compared to a predetermined threshold value.

10. The system of claim 8, wherein the step of calculating a catch rate further comprises:
dividing the catch quantity by the effort quantity for each record in the series.

11. The system of claim 8, wherein the step of predicting a total place quantity further comprises:
generating a linear function based on a depletion model applied to the established series of records, wherein the linear function associated with each record is based on the calculated catch rate and the maintained cumulative catch count; and
calculating the predicted total place quantity based on the generated linear function.

12. The system of claim 11, wherein the depletion model comprises a linear regression model, wherein the predicted total place quantity is based on the generated linear function when the calculated catch rate is equal to zero, and
wherein the method further comprises calculating a confidence value based on a probability distribution associated with the predicted total place quantity.

13. The system of claim 8, wherein the processor is configured by the stored instructions to perform further operations comprising:
estimating a completeness for the region associated with each record, wherein the estimated completeness is based on the cumulative catch count compared to the predicted total place quantity.

14. The system of claim 13, further comprising:
establishing a market value associated with each region based on the estimated completeness.

15. A non-transitory computer-readable medium storing program code which, when executed, is operative to cause an electronic processor to perform the steps of:
capturing a plurality of field reports, wherein each field report comprises a user identifier, a place identifier, a submission timestamp, and an action type selected from the group consisting of Add and Edit;
identifying a subset of the captured field reports according to a region and an initial condition;
determining a catch quantity associated with a series of records established according to a periodic time increment, wherein each catch quantity represents a number of field reports characterized by an Add report type;
determining an effort quantity associated with each record, wherein each effort quantity represents a total number of field reports;
calculating a catch rate associated with each record, wherein each catch rate represents the catch quantity compared to the effort quantity;
maintaining a cumulative catch count associated with each record; and
predicting a total place quantity for the region based on the catch rate and the cumulative catch count associated with a prediction record.

16. The non-transitory computer-readable medium of claim 15, wherein the step of identifying a subset further comprises:
applying a geospatial indexing model that partitions a mapped area of interest into a plurality of regions; and
selecting the region based on the initial condition, wherein the initial condition is based on a minimum increase in catch quantity between subsequent records, compared to a predetermined threshold value.

17. The non-transitory computer-readable medium of claim 15, wherein the step of predicting a total place quantity further comprises:
generating a linear function based on a depletion model applied to the established series of records, wherein the linear function associated with each record is based on the calculated catch rate and the maintained cumulative catch count; and
calculating the predicted total place quantity based on the generated linear function.

18. The non-transitory computer-readable medium of claim 17, wherein the depletion model comprises a linear regression model,
wherein the predicted total place quantity is based on the generated linear function when the calculated catch rate is equal to zero, and
wherein the method further comprises calculating a confidence value based on a probability distribution associated with the predicted total place quantity.

19. The non-transitory computer-readable medium of claim 15, wherein the stored program code which, when executed, is operative to cause an electronic processor to perform the further steps of:
estimating a completeness for the region associated with each record, wherein the estimated completeness is based on the cumulative catch count compared to the predicted total place quantity.

20. The non-transitory computer-readable medium of claim 19, further comprising:
establishing a market value associated with each region based on the estimated completeness.
